(19) United States
(12) Patent Application Publication
(10) Pub. No.: US 2022/0384784 A1
(43) Pub. Date: Dec. 1, 2022

(54) PREPARATION METHOD OF FLUOROCARBON-COATED VSE2 COMPOSITE (VSe2@CF) ANODE ELECTRODE MATERIAL

(71) Applicant: GUANGDONG UNIVERSITY OF TECHNOLOGY, Guangzhou (CN)

(72) Inventors: Miao HE, GUANGZHOU (CN); Chenhao XU, GUANGZHOU (CN); Yefeng FENG, GUANGZHOU (CN); Li CHEN, GUANGZHOU (CN); Deping XIONG, GUANGZHOU (CN)

(21) Appl. No.: 17/334,740

(22) Filed: May 30, 2021

(51) Int. Cl. H01M 4/36; H01M 4/58; H01M 4/62; H01M 10/054; C01B 19/00; B05D 3/12; B05D 3/02

(52) U.S. Cl. CPC H01M 4/366; H01M 4/581; H01M 4/624; H01M 10/054; C01B 19/007; B05D 3/12; B05D 3/0254; H01M 2004/027

(57) ABSTRACT

A preparation method of fluorocarbon-coated VSe₂ composite (VSe₂@CF) anode electrode material, including: weighting and dissolving an acetylacetone oxovanadium (VO(acac)₂) and a selenium dioxide in a solvent to prepare a first solution with a concentration of 0.5-2 mol/L, and stirring the first solution for 0.5 h to obtain a dark green solution; adding the dark green solution with an organic acid to obtain a second solution; transferring the second solution to a polytetrafluoroethylene-lined high-pressure hydrothermal reactor, and holding at a heat insulation temperature for 15-30 h to obtain a third solution; after the third solution is cooled, suction filtering the cooled third solution, and washing the filtered third solution repeatedly to obtain a precipitate; drying the precipitate to obtain a black powder; co-mixing a citric acid solution with the black powder, stirring, ball milling, and drying; and heating up, holding, and finally cooling naturally to room temperature under inert atmosphere.

### TECHNICAL FIELD

The present disclosure relates to the field of new ion battery preparation technologies, specifically an anode material for potassium ion batteries, and in particular to a fluorocarbon-coated VSe₂ composite (VSe₂@CF) anode electrode material and a preparation method thereof.

### BACKGROUND

After decades of development, lithium-ion batteries have been widely applied in digital consumer products, electric vehicles, and energy storage due to high open-circuit voltage, high energy density and long cycle life. Compared to the reserves of sodium (2.36 wt %) and potassium (2.09 wt %) in the earth, the reserves of lithium are about 0.0017 wt %, which is low in nature and expensive, greatly limiting the application of lithium batteries as large-scale energy storage and power batteries. The development of new ion batteries is an inevitable trend in the field of battery energy storage. Due to high storage capacity and wide distribution, potassium becomes an ideal type of ion battery instead of lithium. To improve the energy density, cycle stability and other requirements of potassium-ion batteries, the development of new, stable anode materials for potassium ion batteries has become one of the important methods for potassium ion battery research.

Vanadium diselenide (VSe₂), as a typical graphene-like transition metal selenide, is widely applied in energy, electronic components, and photovoltaic research due to its unique graphene-like structure, excellent electrical properties, mechanical properties, etc. As early as 978, Dr. M. Stanley Whittingham did a study on the application of the VSe₂ material in lithium-ion batteries. It was pointed out that compared with other transition metal selenide materials, VSe₂ has a c/a value of 1.82 and the layer spacing is much greater than other TMDs-like materials. Therefore, VSe₂ may be an ideal anode material for lithium-ion batteries. Conventionally, the yield of the VSe₂ prepared by solvent thermal method as well as hydrothermal method is high, but the products have more impurities and poorer crystalline structure, which may lead to poor conductivity of VSe₂ itself and occurrence of phenomena such as restacking. In this way, capacity may decrease rapidly during battery cycling. A preparation of composites with VSe₂ as a substrate may be an effective way to solve the problem. VSe₂ composites with amorphous carbon and fluorine-rich base materials may be applied in potassium-ion batteries to greatly improve electrochemical performance.

### SUMMARY OF THE DISCLOSURE

The present disclosure is to provide a fluorocarbon-coated VSe₂ composite (VSe₂@CF) anode electrode material and a preparation method thereof. The method is simple and can effectively improve the electronic conductivity of VSe₂ synthesized by the solvothermal method and enhance the multiplicative performance of the anode electrode material, while suppressing the volume expansion and side reactions such as agglomeration during the charging and discharging process, thus improving the cycling performance.

The VSe₂@CF described in the present disclosure is prepared by a combination of solvent thermal and wet ball milling methods. In the composite, the mass fraction of vanadium diselenide is about 60% and that of the carbon fluoride is about 40%. The method may include operations as followed.

1. VO(acac)₂ and selenium dioxide are weighted and dissolved in N-Methyl-Pyrrolidone solvent to prepare a first solution with a concentration of 1 mol/L. The first solution is stirred for 0.5 h to obtain a dark green solution.

2. The dark green solution is added with an organic acid and continued to be stirred for 20 mins to obtain a second solution.

3. The second solution is transferred to a polytetrafluoroethylene-lined high-pressure hydrothermal reactor and is held at 180-220° C. for 20 h to obtain a third solution.

4. After the third solution is cooled, the cooled third solution is suction filtered with deionized water and anhydrous ethanol and washed repeatedly to obtain a black precipitate with metallic luster.

5. The black precipitate with metallic luster is dried at 80° C. to obtain a black powder.

6. Citric acid solution is prepared, co-mixed with the black powder and stirred for 24 h to obtain a fourth solution.

7. A certain amount of PVDF is added to the fourth solution and continued to be stirred for 30 mins to obtain a fifth solution.

8. The fifth solution is put into a ball mill and milled for 24 h to obtain a sixth solution.

9. The sixth solution is dried for 24 h to obtain a brownish grey powder.

10. The brownish gray powder is, under inert atmosphere, raised from 25° C. to 180-250° C. at 1-5° C./min and held for 1-5 h, then raised to 450-600° C. at 1-5° C./min and held for 2-5 h, and naturally cooled to room temperature to obtain the VSe₂@CF anode electrode material.

Notes

In the step 1, the vanadium oxide is acetylacetonate oxovanadium; the selenium oxide is selenium dioxide; the solvent is N-Methyl-Pyrrolidone.

In the step 2, the organic acid is formic acid.

In the step 3, the heat insulation temperature is in a range of 180-220° C.; the heat insulation time is preferably in a range of 14-28 h.

In the step 4, the cooled third solution is suction filtered with the deionized water three times; the cooled third solution is suction filtered with the anhydrous ethanol three times.

In step 5, the black precipitate with metallic luster is preferably dried at 80-100° C. for 18-24 h.

In step 6, in the prepared citric acid solution, the mass of citric acid is roughly 3 times the mass of VSe₂ powder, the solvent is deionized water and preferably the stirring control time is 18-26 h.

In step 7, the mass of PVDF added to the mixture is about 1-3% of the total mass of the mixture. Preferably the mixing time is 15-45 mins.

In step 8, the preferred time for the fifth solution to enter the ball mill for ball milling is 18-26 h.

In step 9, the sixth solution is preferably dried at 50-120° C. for 12-24 h.

In step 10, the inert atmosphere is one or more of nitrogen or argon, preferably argon. The heating rate is preferably 5° C./min, the first holding temperature is preferably 180-250° C., the holding time is preferably 1-3 h, the second holding temperature is preferably 450-600° C., and the holding time is preferably 2-5 h.

The VSe₂@CF prepared by the above method may be applied in potassium-ion batteries as the anode electrode material.

The VSe₂@CF described in the present disclosure has excellent multiplicity performance and cycling stability. The carbon fluoride chemical and vanadium diselenide form a synergistic effect effectively inhibiting the vanadium diselenide agglomeration, while increasing the electronic conductivity and lithium-ion diffusion rate, thus effectively improving the material multiplicity performance and cycle stability.

### BRIEF DESCRIPTION OF THE DRAWINGS

In order to more clearly describe the technical solutions in the embodiments of the present disclosure, the following will briefly introduce the drawings required in the description of the embodiments. Obviously, the drawings in the following description are only some embodiments of the present disclosure. For those skilled in the art, other drawings can be obtained based on these drawings without creative work.

FIG. 1 is an X-ray diffraction (XRD) pattern obtained from XRD analysis of a fluorocarbon-coated VSe₂ composite (VSe₂@CF) and a pure VSe₂ material prepared in an Embodiment 1 of the present disclosure, wherein a indicates the XRD pattern of the VSe₂@CF anode electrode material prepared in the Embodiment 1, and b indicates the XRD pattern of a pure phase laminate VSe₂ material prepared in the Embodiment 1.

FIG. 2 is a scanning electron microscope (SEM) image of the VSe₂@CF prepared in the Embodiment 1 of the present disclosure.

FIG. 3 a SEM image of the pure phase laminate VSe₂ material prepared in the Embodiment 1 of the present disclosure.

FIG. 4 is a transmission electron microscope (TEM) image of the VSe₂@CF prepared in the Embodiment 1 of the present disclosure.

FIG. 5 is a TEM image of the pure phase laminate VSe₂ material prepared in the Embodiment 1 of the present disclosure.

FIG. 6 illustrates charge/discharge cycle performance charts of a button batterie made of the VSe₂@CF prepared in the Embodiment 1 and a button batterie made of a pure phase laminate VSe₂ material prepared in a Comparison 1, at 100 mAg⁻¹ current density.

FIG. 7 illustrates charge/discharge multiplicity performance charts of a button batterie made of the VSe₂@CF prepared in the Embodiment 1 and a button batterie made of a pure phase laminate VSe₂ material prepared in a Comparison 1, at 100-1000 mAg⁻¹ current density.

FIG. 8 illustrates charge/discharge long cycle performance charts of a button batterie made of the VSe₂@CF prepared in the Embodiment 1 and a button batterie made of a pure phase laminate VSe₂ material prepared in a Comparison 1, at 500 mAg⁻¹ current density.

FIG. 9 is a charge/discharge cycle performance chart of a button batterie made of a VSe₂@CF prepared in an Embodiment 2 of the present disclosure at 100 mAg⁻¹ current density.

FIG. 10 is a charge/discharge cycle performance chart of a button batterie made of a VSe₂@CF prepared in an Embodiment 3 of the present disclosure at 100 mAg⁻¹ current density.

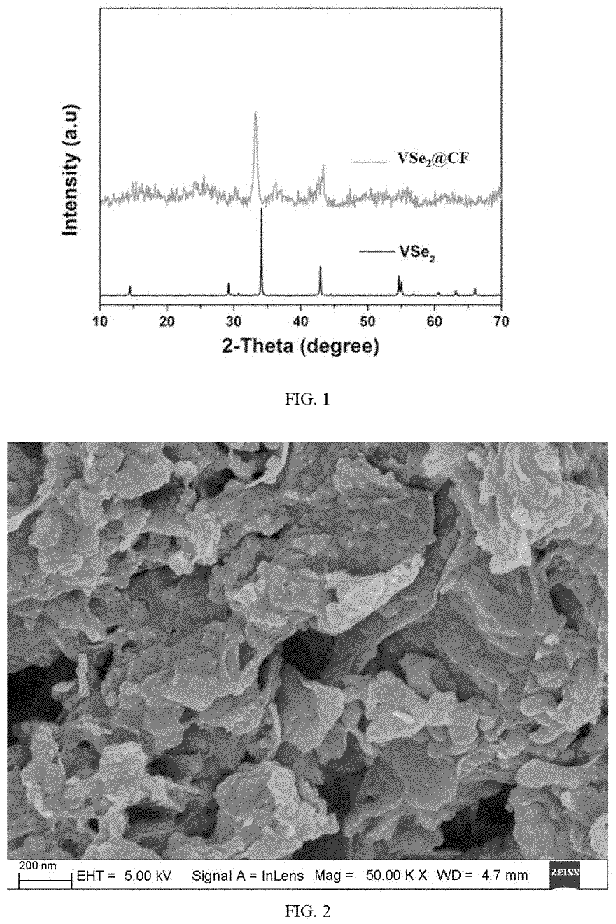

### DETAILED DESCRIPTION

The present disclosure is further described below based on the VSe₂@CF as specific embodiments, but the present disclosure is not limited to these embodiments.

### Embodiment 1

1. Acetylacetone oxovanadium (VO(acac)₂) and selenium dioxide are weighted and dissolved in N-Methyl-Pyrrolidone solvent to prepare a first solution with a concentration of 1 mol/L. The first solution is stirred for 0.5 h to obtain a dark green solution.

2. The dark green solution is added with formic acid and continued to be stirred for 20 mins to obtain a second solution.

3. The second solution is transferred to a polytetrafluoroethylene-lined high-pressure hydrothermal reactor and is held at 200° C. for 24 h to obtain a third solution.

4. After the third solution is cooled, the cooled third solution is suction filtered with deionized water and anhydrous ethanol and washed repeatedly to obtain a black precipitate with metallic luster.

5. The black precipitate with metallic luster is dried at 80° C. for 24 h to obtain a black powder.

6. Citric acid solution is prepared, co-mixed with the black powder and stirred for 24 h to obtain a fourth solution.

7. A certain amount of polyvinylidene fluoride (PVDF) is added to the fourth solution and continued to be stirred for 30 mins to obtain a fifth solution.

8. The fifth solution is put into a ball mill and milled for 24 h to obtain a sixth solution.

9. The sixth solution is dried at 50-120° C. for 12-24 h to obtain a brownish grey powder.

10. The brownish gray powder is, under inert atmosphere, raised from 25° C. to 180-250° C. at 1-5° C./min and held for 1-5 h, then raised to 450-600° C. at 1-5° C./min and held for 2-5 h, and naturally cooled to room temperature to obtain the VSe₂@CF anode electrode material.

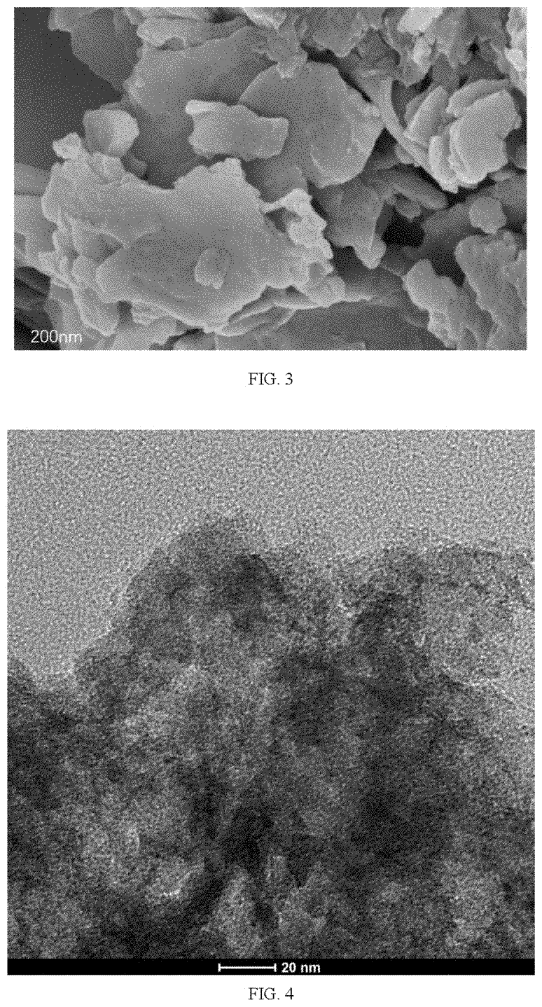

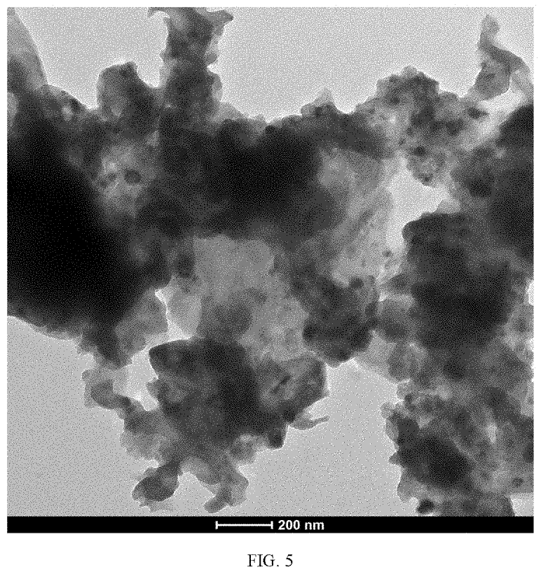

XRD analysis and SEM/TEM analysis are performed on the VSe₂@CF obtained in the Embodiment 1 and a pure phase laminate VSe₂ material obtained in the Embodiment 1. According to the XRD patterns, diffraction peaks of the carbon quantum dot/carbon coated VSe₂ composite are consistent with those of the laminate VSe₂ material before modification, indicating that the carbon quantum dot/carbon coating does not change the physical phase structure of the laminate VSe₂ material. The SEM image of the carbon quantum dot/carbon coated VSe₂ composite (VSe₂@CQD) obtained in the Embodiment 1 is shown in FIG. 2, and the SEM image of the pure phase laminate VSe₂ material in the Embodiment 1 is shown in FIG. 3. As seen from the comparison of FIG. 2 and FIG. 3, after the fluorocarbon coating, the laminar microstructure of the material does not change significantly but the surface is rougher and full of granularity. The TEM image of the VSe₂@CF obtained in the Embodiment 1 is shown in FIG. 4, and the TEM image of the pure phase laminate VSe₂ material in the Embodiment 1 is shown in FIG. 5. As seen from the comparison of FIG. 4 and FIG. 5, after the fluorocarbon coating, a large amount of 2-3 nm fluorocarbon in size is coated on the laminate VSe₂ material, indicating that the fluorocarbon is successfully coated on the VSe₂ material.

The VSe₂@CF prepared in the Embodiment 1, acetylene black, and binder PVDF were dissolved in N-Methyl-Pyrrolidone in the ratio of 7.5:1.5:1.5 for stirring. The resulting slurry was coated on a copper foil and vacuum dried in a vacuum drying chamber for 12 h to obtain a cathode electrode sheet. Battery assembling is performed in an argon-filled glove box with the VSe₂@CF as the cathode, a potassium sheet as the anode, a glass fiber as a diaphragm, and 0.8 M KPF6 in EC:DEC (1:1) as the electrolyte. The assembled button battery is tested for electrochemical performance.

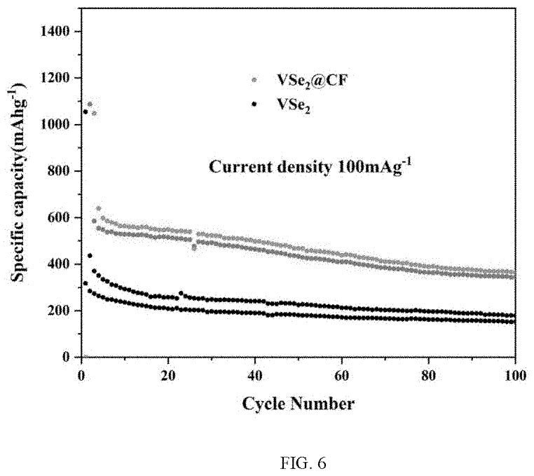

The charge/discharge cycle performance charts of the button batterie made of the VSe₂@CF prepared in the Embodiment 1 and a button batterie made of a pure phase laminate VSe₂ material prepared in a Comparison 1, at 100 mAg⁻¹ current density are shown in FIG. 6. As can be seen from FIG. 6, the capacity of the VSe₂@CF prepared in the Embodiment 1 is 409.0 mAhg⁻¹ after 100 cycles, but the capacity of the pure laminate VSe₂ material is only 208.9 mAhg⁻¹ after 100 cycles. From the above results, the reversible capacity and cyclic stability can be effectively improved using the VSe₂@CF.

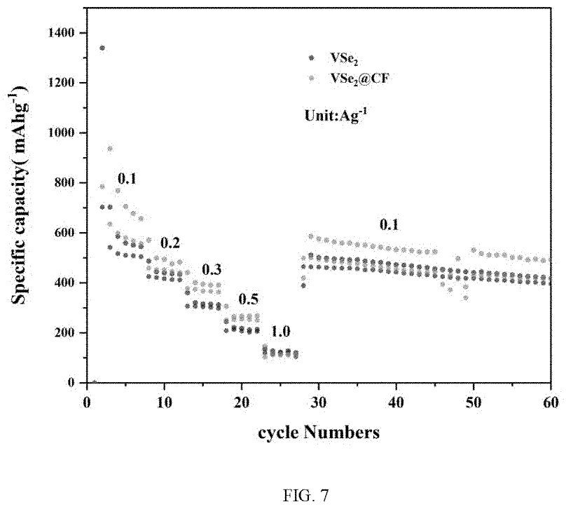

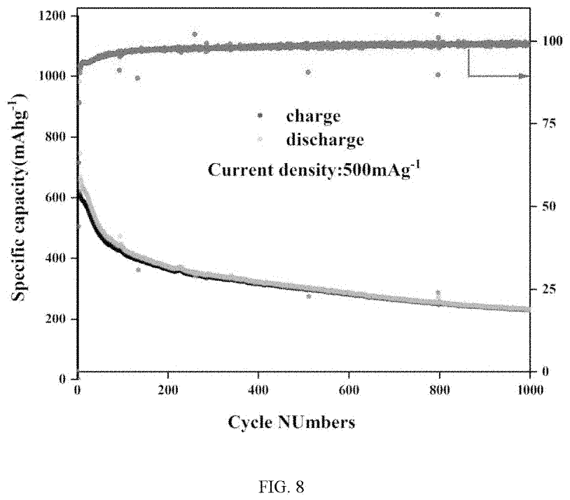

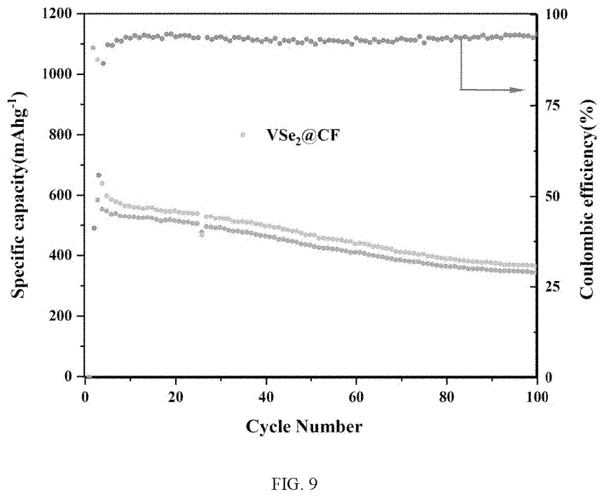

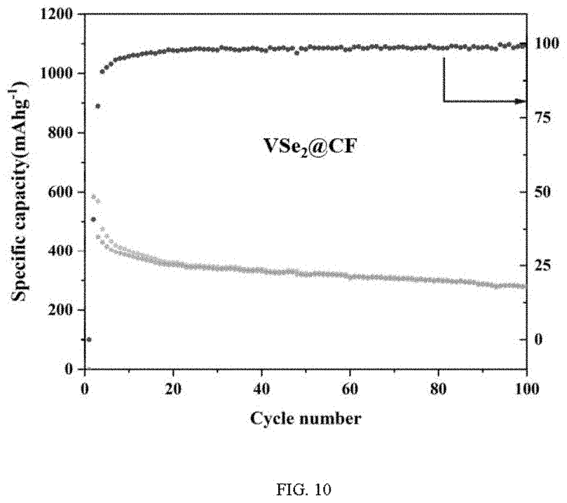

The charge/discharge multiplicity performance charts of the button batterie made of the VSe₂@CF prepared in the Embodiment 1 and the button batterie made of the pure phase laminate VSe₂ material prepared in the Comparison 1, at 100-1000 mAg⁻¹ current density are shown in FIG. 7, respectively. As can be seen from FIG. 7, the reversible capacities obtained for the VSe₂@CQD in the Embodiment 1 at 100, 200, 300, 500, and 1000 mAg⁻¹ current densities are 698.7, 501.2, 401.3, 300.2, and 99 mAhg⁻¹. However, the capacities of the pure laminate VSe₂ material at the same multiplicative current densities are 500, 400.2, 300.2, 200.3 and 99.2 mAhg⁻¹. From the above results, the capacity of the material at high current densities may be effectively improved using the VSe₂@CQD.

The charge/discharge long cycle performance charts of the button batterie made of the VSe₂@CQD prepared in the Embodiment 1 and the button batterie made of the pure phase laminate VSe₂ material prepared in the Comparison 1, at 500 mAg⁻¹ current density are shown in FIG. 8. As can be seen from FIG. 8, the VSe₂@CQD prepared in the Embodiment 1 has the capacity maintained 200.2 mAhg⁻¹ after 1000 cycles. From the above results, the long cycle stability and the stability of the structure can be effectively improved using the VSe₂@CF.

### Embodiment 2

1. VO(acac)₂ and selenium dioxide are weighted and dissolved in N-Methyl-Pyrrolidone solvent to prepare a first solution with a concentration of 1.5 mol/L. The first solution is stirred for 0.5 h to obtain a dark green solution.

2. The dark green solution is added with formic acid and continued to be stirred for 30 mins to obtain a second solution.

3. The second solution is transferred to a polytetrafluoroethylene-lined high-pressure hydrothermal reactor and is held at 200° C. for 24 h to obtain a third solution.

4. After the third solution is cooled, the cooled third solution is suction filtered with deionized water and anhydrous ethanol and washed repeatedly to obtain a black precipitate with metallic luster.

5. The black precipitate with metallic luster is dried at 80° C. for 24 h to obtain a black powder.

6. Citric acid solution is prepared, co-mixed with the black powder and stirred for 24 h to obtain a fourth solution.

7. A certain amount (0.3 g) of PVDF is added to the fourth solution and continued to be stirred for 30 mins to obtain a fifth solution.

8. The fifth solution is put into a ball mill and milled for 24 h to obtain a sixth solution.

9. The sixth solution is dried at 50-120° C. for 12-24 h to obtain a brownish grey powder.

10. The brownish gray powder is raised, under inert atmosphere, from 25° C. to 180-250° C. at 1-5° C./min and held for 1-5 h, then raised to 450-600° C. at 1-5° C./min and held for 2-5 h, and naturally cooled to room temperature to obtain the VSe₂@CF anode electrode material.

The VSe₂@CF prepared in the Embodiment 2, acetylene black, and binder PVDF were dissolved in N-Methyl-Pyrrolidone in the ratio of 7.5:1.5:1.5 for stirring. The resulting slurry was coated on a copper foil and vacuum dried in a vacuum drying chamber for 12 h to obtain a cathode electrode sheet. Battery assembling is performed in an argon-filled glove box with the VSe₂@CF as the cathode, a potassium sheet as the anode, a glass fiber as a diaphragm, and KPF6 as the electrolyte. The assembled button battery is tested for electrochemical performance. Electrochemical performance tests are performed at 25° C. between 0.01 and 3.0 V. The results show that the VSe₂@CF prepared in the Embodiment 2 has excellent multiplicative performance and cycling stability.

### Embodiment 3

1. VO(acac)₂ and selenium dioxide are weighted and dissolved in N-Methyl-Pyrrolidone solvent to prepare a first solution with a concentration of 1.5 mol/L. The first solution is stirred for 0.5 h to obtain a dark green solution.

2. The dark green solution is added with formic acid and continued to be stirred for 30 mins to obtain a second solution.

3. The second solution is transferred to a polytetrafluoroethylene-lined high-pressure hydrothermal reactor and is held at 200° C. for 24 h to obtain a third solution.

4. After the third solution is cooled, the cooled third solution is suction filtered with deionized water and anhydrous ethanol and washed repeatedly to obtain a black precipitate with metallic luster.

5. The black precipitate with metallic luster is dried at 80° C. for 24 h to obtain a black powder.

6. Citric acid solution is prepared, co-mixed with the black powder and stirred for 24 h to obtain a fourth solution.

7. A certain amount (0.3 g) of PVDF is added to the fourth solution and continued to be stirred for 30 mins to obtain a fifth solution.

8. The fifth solution is put into a ball mill and milled for 24 h to obtain a sixth solution.

9. The sixth solution is dried at 50-120° C. for 12-24 h to obtain a brownish grey powder.

10. The brownish gray powder is, under inert atmosphere, raised from 25° C. to 180-250° C. at 1-5° C./min and held for 1-5 h, then raised to 450-600° C. at 1-5° C./min and held for 2-5 h, and naturally cooled to room temperature to obtain the VSe₂@CF anode electrode material.

The VSe₂@CF prepared in the Embodiment 23, acetylene black, and binder PVDF were dissolved in N-Methyl-Pyrrolidone in the ratio of 7.5:1.5:1.5 for stirring. The resulting slurry was coated on a copper foil and vacuum dried in a vacuum drying chamber for 12 h to obtain a cathode electrode sheet. Battery assembling is performed in an argon-filled glove box with the VSe₂@CF as the cathode, a potassium sheet as the anode, a glass fiber as a diaphragm, and KPF6 as the electrolyte. The assembled button battery is tested for electrochemical performance. Electrochemical performance tests are performed at 25° C. between 0.01 and 3.0 V. The results show that the VSe₂@CF prepared in the Embodiment 3 has excellent multiplicative performance and cycling stability.

### Embodiment 4

1. VO(acac)₂ and selenium dioxide are weighted and dissolved in N-Methyl-Pyrrolidone solvent to prepare a first solution with a concentration of 1 mol/L. The first solution is stirred for 0.5 h to obtain a dark green solution.

2. The dark green solution is added with formic acid and continued to be stirred for 20 mins to obtain a second solution.

3. The second solution is transferred to a polytetrafluoroethylene-lined high-pressure hydrothermal reactor and is held at 180° C. for 24 h to obtain a third solution.

4. After the third solution is cooled, the cooled third solution is suction filtered with deionized water and anhydrous ethanol and washed repeatedly to obtain a black precipitate with metallic luster.

5. The black precipitate with metallic luster is dried at 80° C. for 24 h to obtain a black powder.

6. Citric acid solution is prepared, co-mixed with the black powder and stirred for 24 h to obtain a fourth solution.

7. A certain amount (0.1 g) of PVDF is added to the fourth solution and continued to be stirred for 30 mins to obtain a fifth solution.

8. The fifth solution is put into a ball mill and milled for 24 h to obtain a sixth solution.

9. The sixth solution is dried at 50-120° C. for 12-24 h to obtain a brownish grey powder.

10. The brownish gray powder is, under inert atmosphere, raised from 25° C. to 180-250° C. at 1-5° C./min and held for 1-5 h, then raised to 450-600° C. at 1-5° C./min and held for 2-5 h, and naturally cooled to room temperature to obtain the VSe₂@CF anode electrode material.

The VSe₂@CF prepared in the Embodiment 4, acetylene black, and binder PVDF were dissolved in N-Methyl-Pyrrolidone in the ratio of 7.5:1.5:1.5 for stirring. The resulting slurry was coated on a copper foil and vacuum dried in a vacuum drying chamber for 12 h to obtain a cathode electrode sheet. Battery assembling is performed in an argon-filled glove box with the VSe₂@CF as the cathode, a potassium sheet as the anode, a glass fiber as a diaphragm, and KPF6 as the electrolyte. The assembled button battery is tested for electrochemical performance. Electrochemical performance tests are performed at 25° C. between 0.01 and 3.0 V. The results show that the VSe₂@CF prepared in the Embodiment 4 has excellent multiplicative performance and cycling stability.

### Embodiment 5

1. VO(acac)₂ and selenium dioxide are weighted and dissolved in N-Methyl-Pyrrolidone solvent to prepare a first solution with a concentration of 1 mol/L. The first solution is stirred for 0.5 h to obtain a dark green solution.

2. The dark green solution is added with formic acid and continued to be stirred for 20 mins to obtain a second solution.

3. The second solution is transferred to a polytetrafluoroethylene-lined high-pressure hydrothermal reactor and is held at 200° C. for 24 h to obtain a third solution.

4. After the third solution is cooled, the cooled third solution is suction filtered with deionized water and anhydrous ethanol and washed repeatedly to obtain a black precipitate with metallic luster.

5. The black precipitate with metallic luster is dried at 80° C. for 24 h to obtain a black powder.

6. Citric acid solution is prepared, co-mixed with the black powder and stirred for 24 h to obtain a fourth solution.

7. A certain amount of PVDF is added to the fourth solution and continued to be stirred for 30 mins to obtain a fifth solution.

8. The fifth solution is put into a ball mill and milled for 24 h to obtain a sixth solution.

9. The sixth solution is dried at 50-120° C. for 12-24 h to obtain a brownish grey powder.

10. The brownish gray powder is, under inert atmosphere, raised from 25° C. to 180-250° C. at 1-5° C./min and held for 1-5 h, then raised to 450-600° C. at 1-5° C./min and held for 2-5 h, and naturally cooled to room temperature to obtain the VSe₂@CF anode electrode material.

The VSe₂@CF prepared in the Embodiment 5, acetylene black, and binder PVDF were dissolved in N-Methyl-Pyrrolidone in the ratio of 7.5:1.5:1.5 for stirring. The resulting slurry was coated on a copper foil and vacuum dried in a vacuum drying chamber for 12 h to obtain a cathode electrode sheet. Battery assembling is performed in an argon-filled glove box with the VSe₂@CF as the cathode, a potassium sheet as the anode, a glass fiber as a diaphragm, and KPF6 as the electrolyte. The assembled button battery is tested for electrochemical performance. Electrochemical performance tests are performed at 25° C. between 0.01 and 3.0 V. The results show that the VSe₂@CF prepared in the Embodiment 5 has excellent multiplicative performance and cycling stability.

The preparation method of the VSe₂@CF belongs to the field of potassium-ion battery anode materials and preparation technologies. By compounding carbon, PVDF, and VSe₂, a synergistic effect is produced among the three components. The fluorocarbon can increase the electronic conductivity and potassium-ion diffusion rate of the material and can inhibit agglomeration of the active substance VSe₂. Therefore, the prepared composites have excellent electrochemical properties and exhibit good multiplicative performance and cycling stability. The process method is simple, low cost, environmentally friendly and suitable for large-scale industrial production.

What is claimed is:

1. A preparation method of a fluorocarbon-coated VSe₂ composite (VSe₂@CF) anode electrode material, comprising:
weighting and dissolving a vanadium oxide and a selenium oxide in a solvent to prepare a first solution with a concentration of 0.5-2 mol/L, and stirring the first solution for 0.5 h to obtain a dark green solution;
adding the dark green solution with an organic acid, and continuing stirring for 0.5 h to obtain a second solution;
transferring the second solution to a polytetrafluoroethylene-lined high-pressure hydrothermal reactor, and holding at a heat insulation temperature for a heat insulation time to obtain a third solution;
after the third solution is cooled, suction filtering the cooled third solution with deionized water and anhydrous ethanol, and washing the filtered third solution repeatedly to obtain a black precipitate with metallic luster;
drying the black precipitate with metallic luster to obtain a black powder;
preparing a citric acid solution, co-mixing the citric acid solution with the black powder, and stirring for 24 h to obtain a fourth solution;
adding a certain amount of polyvinylidene fluoride (PVDF) to the fourth solution and continuing stirring to obtain a fifth solution;
putting the fifth solution into a ball mill and milling to obtain a sixth solution;
drying the sixth solution to obtain a brownish grey powder; and
performing heating process on the brownish gray powder to obtain the VSe₂@CF anode electrode material.

2. The preparation method according to claim 1, wherein a mass fraction of VSe₂ in the VSe₂@CF anode electrode material is 60% and a mass fraction of carbon quantum dots/carbon is 40%.

3. The preparation method according to claim 1, wherein the vanadium oxide is acetylacetonate oxovanadium; the selenium oxide is selenium dioxide; the solvent is N-Methyl-Pyrrolidone.

4. The preparation method according to claim 1, wherein the organic acid is formic acid.

5. The preparation method according to claim 1, wherein in the transferring the second solution to the polytetrafluoroethylene-lined high-pressure hydrothermal reactor, and holding at the heat insulation temperature for the heat insulation time to obtain the third solution, the heat insulation temperature is in a range of 180-220° C.; the heat insulation time is in a range of 20-24 h.

6. The preparation method according to claim 1, wherein after the third solution is cooled, in the suction filtering the cooled third solution with deionized water and anhydrous ethanol, and washing the filtered third solution repeatedly to obtain the black precipitate with metallic luster, the cooled third solution is suction filtered with the deionized water and washed three times; the cooled third solution is suction filtered with the anhydrous ethanol and washed three times.

7. The preparation method according to claim 1, wherein in the drying the black precipitate with metallic luster to obtain the black powder, the black precipitate with metallic luster is dried at 80-100° C. for 18-24 h.

8. The preparation method according to claim 1, wherein in the co-mixing the citric acid solution with the black powder, and stirring for 24 h to obtain the fourth solution, the citric acid solution is co-mixed and stirred with the black powder at 25-30° C.

9. The preparation method according to claim 1, wherein in the adding a certain amount of PVDF to the fourth solution and continuing stirring to obtain the fifth solution, the stirring is performed for 30 mins.

10. The preparation method according to claim 1, wherein in the putting the fifth solution into the ball mill and milling to obtain the sixth solution, the milling is performed 18-24 h.

11. The preparation method according to claim 1, wherein in the drying the sixth solution to obtain the brownish grey powder, the sixth solution is dried at 50-120° C. for 12-24 h.

12. The preparation method according to claim 1, wherein in the performing heating process on the brownish gray powder to obtain the VSe₂@CF anode electrode material, the brownish gray powder is raised from 25° C. to 180-250° C. at 1-5° C./min and held for 1-5 h under inert atmosphere, then raised to 450-600° C. at 1-5° C./min and held for 2-5 h, and naturally cooled to room temperature to obtain the VSe₂@CF anode electrode material.

13. The preparation method according to claim 9, wherein in the putting the fifth solution into the ball mill and milling to obtain the sixth solution, the milling is performed 18-24 h.
